(19) United States
(12) Patent Application Publication
(10) Pub. No.: US 2010/0119864 A1
(43) Pub. Date: May 13, 2010

(54) HEAT-RESISTANT COMPONENT

(75) Inventors: Hiroyuki Ochiai, Tokyo (JP); Takashi Furukawa, Tokyo (JP); Mitsutoshi Watanabe, Tokyo (JP); Issei Otera, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: IHI Corporation, Tokyo (JP)

(21) Appl. No.: 12/532,745

(22) PCT Filed: Mar. 25, 2008
(86) PCT No.: PCT/JP08/55592

§ 371 Date: Sep. 23, 2009

(30) Foreign Application Priority Data
Mar. 26, 2007 (JP) 2007-080239

(51) Int. Cl. B32B 5/14; B32B 15/04; B32B 15/01

(52) U.S. Cl. 428/610; 428/457; 428/615

(57) ABSTRACT

In a heat-resistant component of a TiAl intermetallic component, in its main body having a friction region subject to friction with other components, a coating discharge-deposited by a consumable electrode covers the friction region.

### TECHNICAL FIELD

The present invention relates to heat-resistant components such as a turbine blade, an impeller of a supercharger or such, which keep sufficient strength under high-temperature environments, and a method of a surface treatment.

### BACKGROUND ART

Gas turbine engines are used as power sources of jet airplanes, and a gas turbine engine comprises a gas turbine having rotors and stators that alternate in its axial direction. Each of the rotors has a plurality of rotor blades arranged in its circumferential direction and receives driving force from hot gas to rotate. Each of the rotor blades has a component referred to as “tip shroud” at a tip end of its outer periphery. Tip shrouds are arranged in contact with each other in the circumferential direction so as to reduce escape of air rearward by means of tip seals at these tip ends. As the rotors rotate, faces, where the tip shrouds are mutually in contact, are subject to severe friction. To protect the rotors from such friction, the tip shrouds are often treated with appropriate coating at particular regions thereof.

Japanese Patent Application Laid-open No. H05-148615 discloses an art related to the present invention.

As a material for the gas turbine engines, titanium-aluminum (TiAl) intermetallic compounds start to attract an attention. The titanium-aluminum intermetallic compounds are not only lightweight but also of high high-temperature strength, and therefore they are attractive materials as base materials applied to gas turbine engines, in particular rotors.

### DISCLOSURE OF INVENTION

The present invention is intended for providing heat-resistant components made of Ti—Al intermetallic compounds susceptible to defects such as a crack, which are treated with coating capable of suppressing deterioration of properties and shortening of the lifetime caused by execution of the coating, and a method of a surface treatment which enables such coating.

According to a first aspect of the present invention, a heat-resistant component subject to friction with other component under high-temperature environments is comprised of a main body of a TiAl intermetallic compound having a friction face subject to friction with the other component; and an abrasion-resistant coating coated on the friction face, the abrasion-resistant coating being formed by executing discharge-deposition by a consumable electrode of an abrasion-resistant metal.

Preferably, the main body is heated at a brittle-ductile transition temperature or higher temperatures prior to the discharge-deposition. Still preferably, the abrasion-resistant coating is formed by executing the discharge-deposition in oil including fine powder. Alternatively preferably, the friction face is treated with a peening treatment prior to the discharge-deposition. Further preferably, the abrasion-resistant coating comprises a Co alloy including Cr. Still further preferably, the consumable electrode is formed from a powder comprising a Co alloy including Cr by any method selected from the group of compression, compression and at least partial sintering after the compression, slip casting, MIM, and spraying. Alternatively preferably, the heat-resistant component is further comprised of a fused layer in which a composition gradiently changes in a thickness direction, between the coating and the main body.

According to a second aspect of the present invention, a heat-resistant component subject to friction with other component under high-temperature environments is comprised of a main body of a TiAl intermetallic compound having a friction face subject to friction with the other component; and a coating having abrasiveness coated on the friction face, the coating being formed by executing discharge-deposition from a consumable electrode of a metal having abrasiveness and a ceramic.

Preferably, the main body is heated at a brittle-ductile transition temperature or higher temperatures prior to the discharge-deposition. Still preferably, the coating of abrasiveness is formed by executing discharge-deposition in oil including fine powder. Alternatively preferably, the friction face is treated with a peening treatment prior to the discharge-deposition. Further preferably, the coating having abrasiveness comprises a metal and a ceramic, the metal including one selected from the group of cobalt alloys and nickel alloys, the ceramic including one or more selected from the group of cBN, TiC, TiN, TiAlN, TiB₂, WC, SiC, Si₃N₄, Cr₃C₂, Al₂O₃, ZrO₂—Y, ZrC, VC, and B₄C. Still further preferably, the consumable electrode comprises a metal and a ceramic, the metal including one selected from the group of cobalt alloys and nickel alloys, the ceramic including one or more selected from the group of cBN, TiC, TiN, TiAlN, TiB₂, WC, SiC, Si₃N₄, Cr₃C₂, Al₂O₃, ZrO₂—Y, ZrC, VC, and B₄C, the consumable electrode being formed from a powder of the metal and the ceramic by any method selected from the group of compression, compression and at least partial sintering after the compression, slip casting, MIM, and spraying. Alternatively preferably, the heat-resistant component is further comprised of a fused layer in which a composition gradiently changes in a thickness direction, between the coating and the main body.

### BRIEF DESCRIPTION OF DRAWINGS

FIG. 1 is a perspective view of a rotor blade of a gas turbine engine in accordance with an embodiment of the present invention.

FIG. 2 is a schematic view of a relation between a tip end of the rotor blade and a honeycomb member at an inside of an engine case.

FIG. 3 is a schematic view of the gas turbine engine to which the rotor blade is applied.

FIG. 4 is a schematic drawing of an electric spark machine used for discharge-deposition in accordance with the present embodiment.

FIG. 5 is a schematic drawing of a peening step in accordance with the present embodiment.

FIG. 6 is a schematic drawing explaining a step of forming a first coating.

FIG. 7 is a schematic drawing explaining a step of forming a second coating.

FIG. 8 is a graph showing a relation between a thickness of a fused layer and an adhesion strength of the coating.

FIG. 9 is a graph showing a relation between the thickness of the fused layer and a deformation of a base body.

FIG. 10 is an example in which discharge-deposition is executed on a face not treated with peening.

FIG. 11 is an example in which discharge-deposition is executed on a face treated with peening.

### BEST MODE FOR CARRYING OUT THE INVENTION

Throughout the specification and appended claims, several terms are used in accordance with the following definitions. The term “discharge-deposition” is defined and used as, with applying a consumable electrode instead of a non-consumable electrode to an electric spark machine, usage of discharge in the electric spark machine for consuming the electrode instead of machining a workpiece to deposit a material of the electrode or a reaction product between the material of the electrode and a processing liquid or gas onto the workpiece. Further, the term “discharge-deposit” is defined and used as a transitive verb of the term “discharge-deposition”. Furthermore, the phrase “consist essentially of” means to partially closely regulate ingredients, namely, to exclude additional unspecified ingredients which would affect the basic and novel characteristics of the product defined in the balance of the claim but permit inclusion of any ingredients, such as impurities, which would not essentially affect the characteristics.

Titanium-aluminum (TiAl) intermetallic compounds have superiority in light of the lightweight and the excellent high-temperature strength. On the other hand, the TiAl intermetallic compounds lack ductility around the normal temperature and are therefore troublesome in light of machining and surface treatments. If one would use any method involving melting to execute the aforementioned coating, its thermal shock is likely cause them to crack. If one would apply spraying so as to reduce generation of cracks, this process requires bothersome tasks including masking any portions except a subject portion and further obtained coatings are likely to peel off. The present inventors has carried out studies about a cause of crack generation at the time of forming the aforementioned coating. As a result, it has become apparent that surfaces of a TiAl intermetallic compound receives heat to expand and this leads to a difference in thermal expansion relative to portions just under the surfaces remaining at relatively low temperatures, which produces an excessive tensile stress in the portions just under the surfaces, or the coating layers covering the surfaces impose constraint on shrinkage of the surfaces in its subsequent cooling stage and therefore produces an excessive tensile stress in the surfaces, either or both of which cause the cracks. The cracks and progress of the cracks apparently degrades properties such as fatigue.

The present inventors have diligently studied about means for forming coatings which hardly peel off on heat-resistant components made of TiAl intermetallic compounds, which reduce tensile stress such as above so as to prevent crack generation and, even if cracks are generated at surfaces, suppress degradation of properties, in particular the fatigue property, and resultantly reached the present invention.

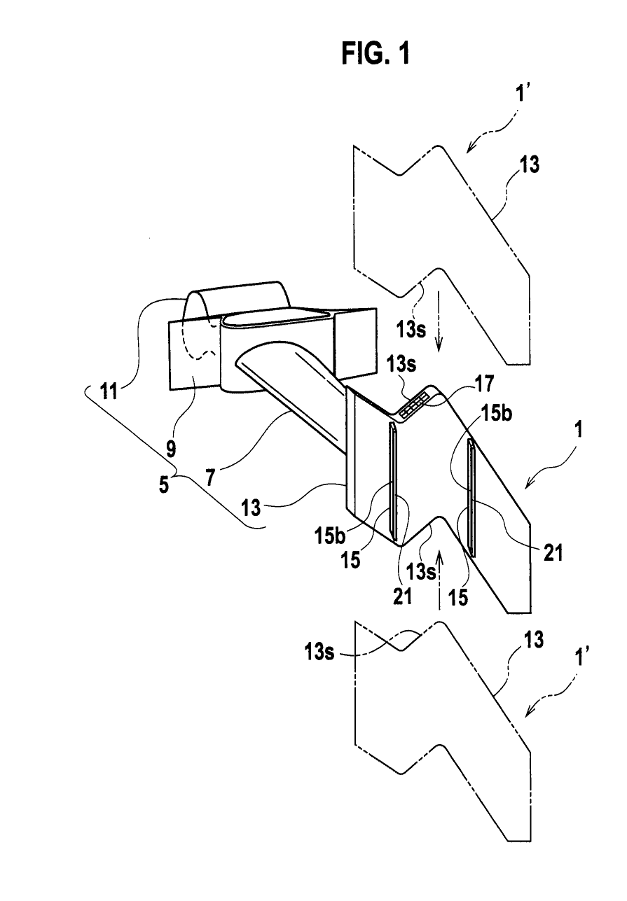

An embodiment of the present invention will be described hereinafter with reference to the drawings of FIG. 1 through FIG. 7.

Throughout the present specification, drawings and appended claims, a distal end and a proximal end in regard to any rotor blade respectively mean radially outer and inner ends with respect to an axis of a gas turbine engine. Further, “forward” and “rearward” respectively mean toward directions corresponding to upstream and downstream directions in a flow of air in the gas turbine engine. In FIG. 3 for example, an arrow FF indicates the forward direction and an arrow FR indicates the rearward direction.

A rotor blade 1 in accordance with the embodiment of the present invention is, as shown in FIG. 3, installed and then used in a gas turbine engine 3 so as to rotate in a unitary manner with a disk about an axial center C. The rotor blade 1 along with other rotor blades 1′ is, as shown in FIG. 1, arranged around the axial center C at even intervals in its circumferential direction.

A main body 5 of the rotor blade 1 is comprised of a blade 7, a platform 9 integral with a proximal end thereof, a dovetail 11 further integral with a proximal end thereof, and one or more (a pair in the drawing) tip seals 15 integral with a distal end face thereof. The main body 5 consists essentially of a TiAl intermetallic compound.

The blade 7 is a blade having an airfoil cross-section so as to obtain driving force from hot gas to rotate. The platform 9 is of a rectangular plate shape and, in combination with platforms of the adjacent rotor blades 1′, forms a cylindrical periphery around the axial center C. The dovetail 11 is so configured as to engage with a disk not shown in the drawing.

The tip shroud 13 is arranged to contact with tip shrouds of the adjacent rotor blades 1′ in its circumferential direction, and these shrouds as a whole form a cylindrical periphery around the axial center C. Friction faces 13s at side faces of the tip shroud 13, which are subject to friction with side faces of the adjacent tip shrouds in operation, are coated with first coatings 17. The first coating 17 is made of any abrasion-resistant metal, which is preferably but not limited to a Co—Cr alloy. A coating method for the first coating 17 will be described later in further detail.

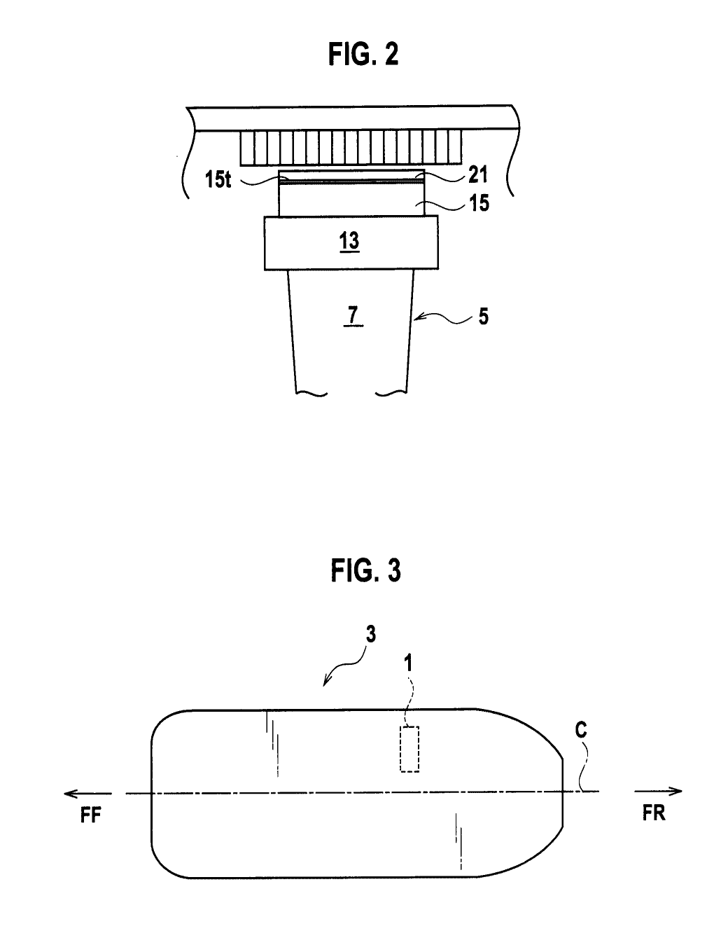

Referring to FIG. 1 and FIG. 2, the tip seals 15 are respectively ribs projecting substantially in parallel with the rotation direction of the rotor blade 5 so as to cause mutual friction with a honeycomb member 19 which a casing of the gas turbine engine 3 has. (For convenience of illustration, FIG. 2 shows that the tip seal 15 and the honeycomb member 19 stand apart, however, these members do mutual friction in practice.) Friction portions 15t around the top of the tip seals 15, which are portions subject to mutual friction with the honeycomb member 19, are coated with second coatings 21 having abrasiveness.

Meanwhile, “abrasiveness” of a component is a property of abrading an opposite component having a relation of mutual friction and also a property in which the friction causes the opposite component to be preferentially scraped off but the component itself is protected from damage by the friction. Throughout the present specification and appended claims, the term “abrasiveness” is used in accordance with this definition.

The second coating 21 having abrasiveness is preferably made of a metal and a ceramic, and further preferably, but not limited to, the metal is one selected from the group of cobalt alloys and nickel alloys and the ceramic is one or more selected from the group of cBN, TiC, TiN, TiAlN, TiB₂, WC, SiC, Si₃N₄, Cr₃C₂, Al₂O₃, ZrO₂—Y, ZrC, VC, and B₄C. A coating method for the second coating 21 will be described later in further detail.

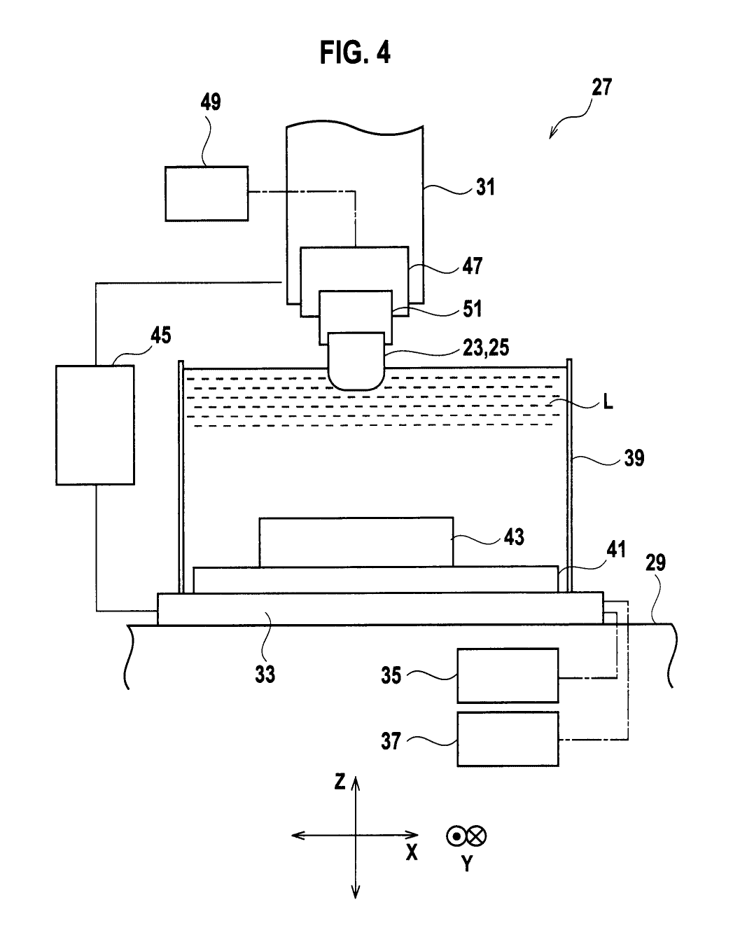

The first coating 17 and the second coating 21 are formed by using an electric spark machine 27 as shown in FIG. 4 and by means of discharge-deposition. The electric spark machine 27 used for discharge-deposition is comprised of a bed 29, a table 33 horizontally movably provided on the bed 29, a support plate 41 and a jig 43 both moving integrally with the table 33, and a processing bath 39 for storing a processing liquid (or, a processing gas) L. A subject body for the discharge-deposition is to be attached on the jig 43 in the processing bath 39. The electric spark machine 27 is further comprised of a column 31 as being opposed to the bed 29, a processing head 47 vertically movably attached to the column 31, and a holder 51 configured to attach an electrode 23 (or 25) to a lower end of the processing head 47. The electric spark machine 27 is further comprised of an external power supply 45 to apply voltage between the table 33 and the processing head 47. To the table 33, an X-axis servomotor 35 and a Y-axis servomotor 37 are connected so as to drive the table, thereby controllably driving the table 33 along the X-axis and the Y-axis (namely, horizontally). Further to the processing head 47, a Z-axis servomotor 49 is drivingly connected, thereby controllably driving the processing head along the Z-axis, namely vertically.

In the discharge-deposition, the electrode 23, 25 is not a non-consumable electrode used for ordinary electric spark machining and instead a consumable electrode made of a formed body having a relatively coarse structure in which a powder is compressed by pressing and then formed. Instead of the formed body by compression, one may use an electrode in which, a heat treatment is executed to cause at least partial sintering after formation by compression, or formation is executed by slip casting, MIM (Metal Injection Molding), spraying or such.

The subject body is set in the electric spark machine 27, driven in the processing bath 39 by the X-,Y-axes servomotors 35, 37 so that its subject region is made opposed to the electrode 23, 25, and, by drive of the Z-axis servomotor 49, the subject body is made closed to the electrode 23, 25. Then, in a case of ordinary electric spark machining, a pulsing current is supplied from the external power supply 45 to generate a pulsing discharge between the subject region and the electrode. However, in the discharge-deposition, instead of the subject region being consumed, the electrode 23, 25 is consumed to deposit the material of the electrode 23, 25 or a reaction product between the material of the electrode and a processing liquid L onto the subject region. The processing liquid L is preferably an insulating liquid such as oil. Not only does the deposition adhere on the subject region but also use the energy of the discharge in part to bring about phenomena such as diffusion and fusion between the deposition and the subject body, and also among particles of the deposition mutually.

In the present embodiment, the subject body is the main body 5 of the rotor blade 1, and the subject region is the friction face 13s or the friction portion 15t. As mentioned above, the first coating 17 covers the friction face 13s and the second coating 21 covers the friction region 15t. Coating methods of them will be described hereinafter in detail.

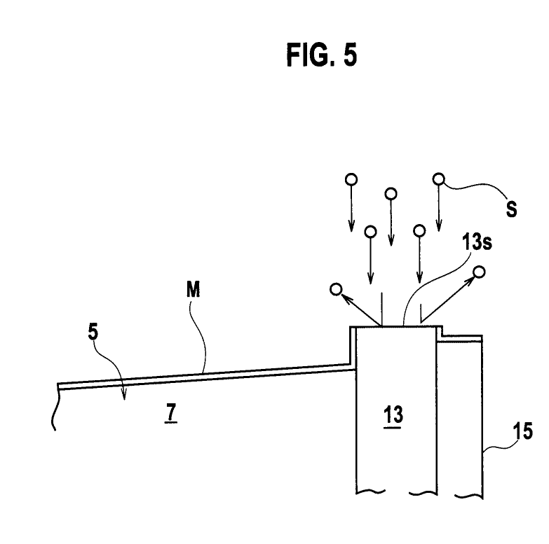

First, as schematically shown in FIG. 5, peening with proper small balls S or such is executed on the friction face 13s as the subject region by means of any known method. Prior to the peening, masking M may be executed on portions except the friction face 13s. The peening leaves compressive stress in the friction face 13s. The residual compressive stress balances with tensile stress, which may be generated in the friction face, thereby canceling or reducing tensile stress as being left in the balance. In a similar manner, peening is also executed on the friction portion 15t. In a case where tensile stress is expected to be relatively small, peening may be omitted.

By using the electric spark machine 27, the friction face 13s is coated with the first coating 17 and the friction region 15t is coated with the second coating 21. In regard to the first coating 17, the first electrode 23 of consumability as mentioned above made of an abrasion-resistant metal such as a Co alloy including Cr according to the aforementioned example is used. In regard to the second coating 21, the second electrode 25 of consumability as mentioned above made of a metal and a ceramic, where the metal is one selected from the group of cobalt alloys and nickel alloys and the ceramic is one or more selected from the group of cBN, TiC, TiN, TiAlN, TiB₂, WC, SiC, Si₃N₄, Cr₃C₂, Al₂O₃, ZrO₂—Y, ZrC, VC, and B₄C, according to the aforementioned example is used. The first electrode 23 and the second electrode 25 are formed in shapes respectively complementary to the friction face 13s and the friction portion 15t as the subject regions.

The main body 5 of the rotor blade 1 is attached onto the jig 43 in the processing bath 29 so that the friction face 13s is made opposed to the processing head 47. The first electrode is attached to the holder 51 of the processing head 47. Into the processing bath 29, the processing liquid L is poured. The processing liquid L may properly include fine powder having electric conductivity. As the fine powder mediates, the discharge can be propagated a longer distance via the fine powder. Therefore, a gap between the electrode 23 and the main body 5, namely interelectrode distance, can be made larger, and by the same token it is enabled to generate discharge over a wider area. This results in reduction of local heat generation and further leads to prevention or suppression of crack generation caused by thermal stress. As the fine powder, any substance keeping electric conductivity even if it fuses and condenses by the discharge or causes chemical reaction with oil to give a carbide is preferable. As such a substance, any substance identical to the electrode 23 or silicon is preferable. Further, in regard to the particle size of the fine powder, if it is overly large, uniform suspension in the oil becomes difficult, however if it is overly small, condensation is likely to occur. Therefore, the particle size is preferably in the range of 0.5-2 μm. Further in regard to the amount relative to oil, if it is overly large, uniform suspension in the oil becomes difficult, however if it is overly small, the effect of capability of increasing interelectrode distance cannot be obtained. Therefore, it is preferably 5-15 weight %.

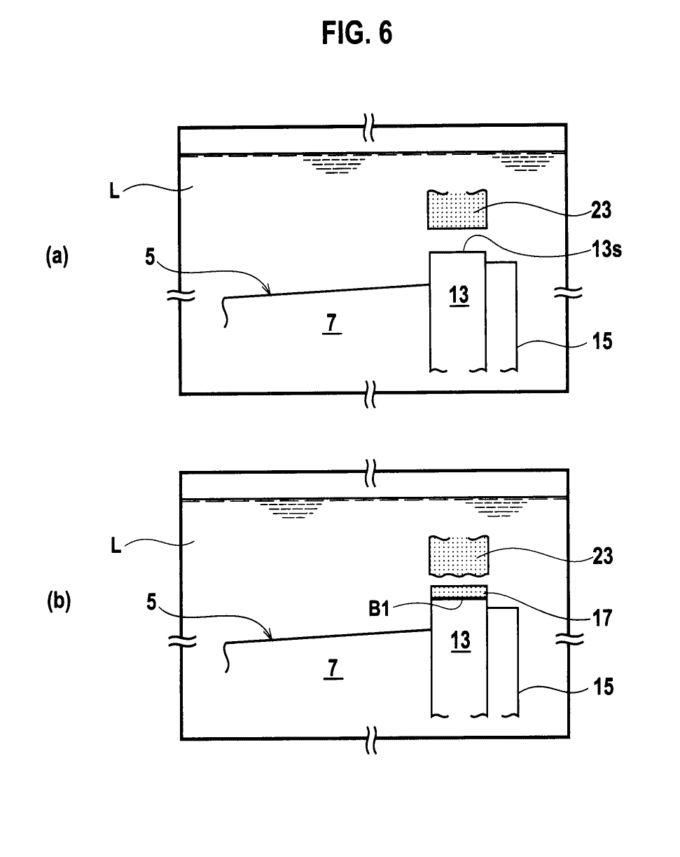

To make the friction face 13s opposed to and close to the first electrode 23, the servomotors 35,37,49 are properly driven. FIG. 6(a) is a schematic drawing in which the friction face 13s is opposed to and close to the first electrode 23.

To supply pulsing electric power from the external power supply 45, pulsing discharge is generated between the first electrode 23 and the friction face 13s in the processing liquid L. By means of the discharge, the first electrode 23 is consumed so that the Co alloy including Cr which constitutes the first electrode 23 is deposited on the friction face 13s. Not only does the Co alloy including Cr adhere on the friction face 13s but also use the energy of the discharge in part to bring about diffusion and fusion, thereby generating the first coating 17 as the deposition firmly adhering on the friction face 13s. As the first electrode 23 is consumed, the gap between the first electrode 23 and the friction face 13s is gradually broadened. Therefore, to drive the Z-axis servomotor 49 at a very slow speed, the processing head 47 is gradually moved downward so as to maintain the discharge and the discharge is kept to last until desired thickness is given.

The first coating 17 has a characteristic structure which contains pores and fine powder but is not coarse, as reflecting the process of the discharge-deposition. Based on this characteristic, a skilled person can clearly distinguish the structure of the first coating 17 from structures of coatings formed by spraying, electrodeposition or such by means of microscopic structural observation of these sections or such.

By the aforementioned diffusion and fusion, at a boundary of the first coating 17 and the friction face 13, a fusion layer B1 in which a composition gradiently changes in its thickness direction is generated. The thickness of the fusion layer B1 is not limited to but may be preferably made to be 1 μm or more and 10 μm or less, or more preferably 3 μm or more and 10 μm or less, because adhesion strength would be reduced if it is too thin and excessive tensile stress in the friction face 13s would be induced if it is too thick. Therefore the thickness should be regulated by properly controlling a condition of the discharge, resultantly the thickness is preferably 1 μm or more and 10 μm or less, or more preferably 3 μm or more and 10 μm or less. An appropriate discharge condition is that a peak current is 30A or less and a pulse width is 8 μs or less, or more preferably a peak current is 20A or less and a pulse width is 8 μs or less.

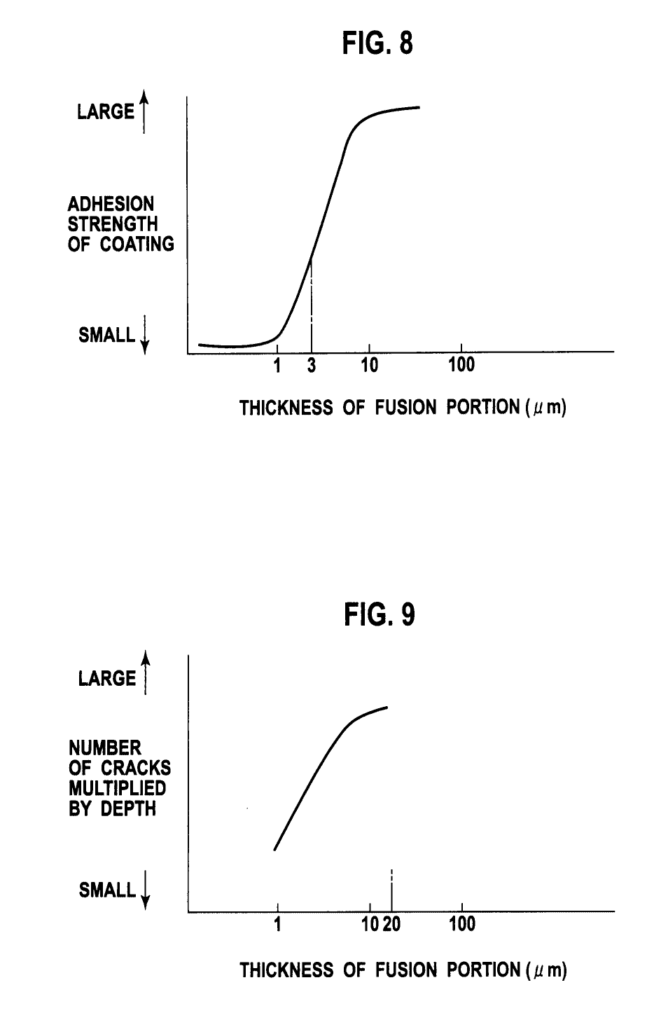

FIG. 8 is a result of studying a relation between the thickness of the fusion layer B1 and the adhesion strength of the first coating 17 obtained by variously changing the discharge condition so as to change the thickness of the fusion layer B1 with respect to the friction face 13s without being treated with peening. The axis of abscissas represents thicknesses of the fusion layer B1 in a logarithmic display and the axis of ordinates represents adhesion strengths rendered into dimensionless numbers. It becomes clear that, when the thickness exceeds 1 μm, the adhesion strength increases as the thickness increases but this effect is saturated beyond 20 μm. FIG. 9 is a result of studying a relation between the thickness of the fusion layer B1 and the number multiplied by the depth of cracks in the base member, and Table 1 is a result of studying a relation between the thickness of the fusion layer B1 and presence of generated cracks. Since deformation of the base member is caused by tensile stress generated in the friction face 13s, the number multiplied by the depth of cracks in the base member can be an index of the tensile stress. The axis of abscissas represents thicknesses of the fusion layer B1 in a logarithmic display and the axis of ordinates represents numbers multiplied by depths of cracks rendered into dimensionless numbers. As being apparent from FIG. 9, according to increase in the thickness of the fusion layer B1, the deformation of the base member increases and in particular becomes prominent beyond 10 μm. In other words, it becomes clear that, as the thickness of the fusion layer B1 is smaller, the tensile stress generated in the friction face 13s gets smaller and its effect would be very small below 10 μm. Based on such knowledge, the thickness of the fusion layer B1 is preferably 1 μm or more and 10 μm or less, more preferably 3 μm or more and 10 μm or less.

TABLE 1
A relation between the thickness of
the fusion layer and presence of generated cracks

| | | Thickness of | | | | | |
|---|---|---|---|---|---|---|---|
| | | the fusion | | | | | |
| | | layer (μm) | | | | | |
| | | 2 | 5 | 7 | 10 | 12 | 15 |
| cracks | Number | very | few | moderate | moderate | many | many |
| | | few | | | | | |
| | Depth | very | shallow | deep | shallow | deep | deep |
| | | shal- | | | | | |
| | | low | | | | | |

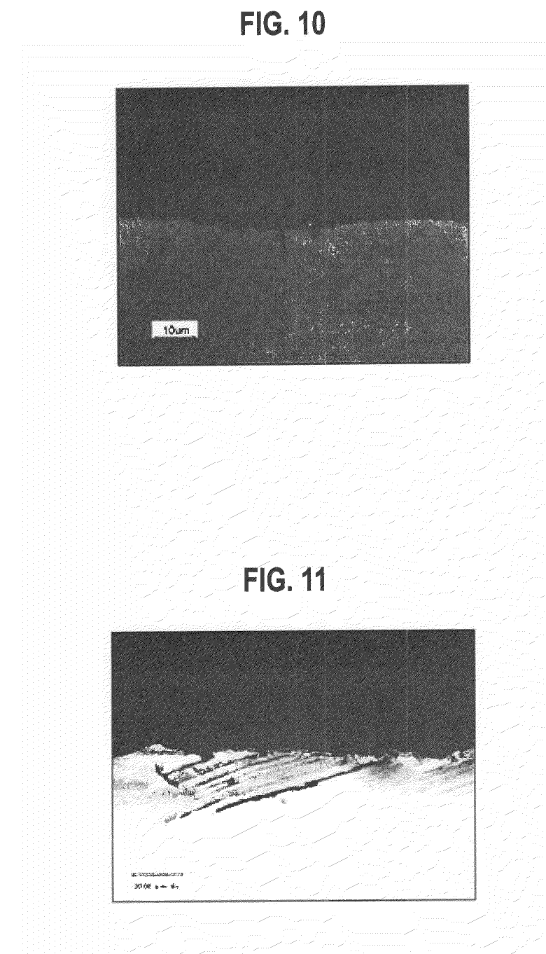

Further, such comparison is carried out about shapes of cracks depending on execution or not of the peening. FIG. 10 shows an example in which discharge-deposition is executed on the face without peening. The cracks are nearly perpendicular to the face and deeply propagate to penetrate the lamellar layer, and therefore the shape is not preferable in light of maintenance of strength. FIG. 11 shows an example in which discharge-deposition is executed on the face with peening. The cracks are oblique to the face and propagate in a manner as to peel off the lamellar layer. More specifically, even if the cracks are generated, the cracks are in a shape which does not really affect its strength. Therefore, execution of peening prior to the discharge-deposition is preferable.

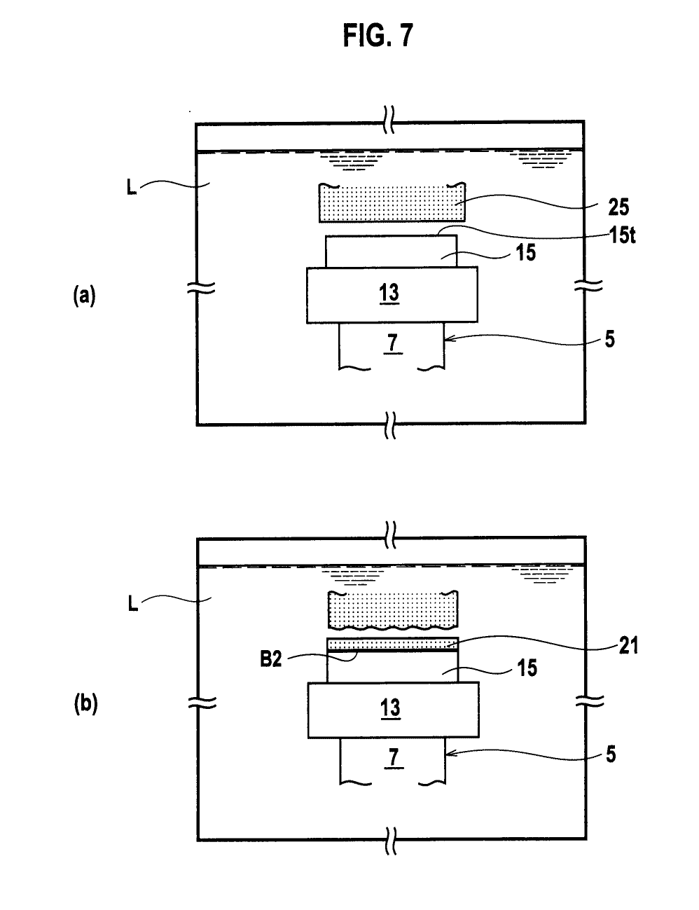

Next, as shown in FIG. 7(a), the main body 5 of the rotor blade 1 is turned around and then the main body 5 is attached onto the jig 43 so that the friction portion 15t is opposed to the processing head 47. Further, instead of the first electrode 23, the second electrode 25 is attached to the holder 51. As shown in FIG. 7(b), the servomotors 35, 37, 49 are driven so that the friction portion 15t is made close to the second electrode 25 and discharge is made generated between the second electrode 25 and the friction portion 15t. By means of the discharge, the second electrode 25 is consumed so that the metal and the ceramic constituting the electrode 25 are deposited on the friction portion 15t, thereby generating the second coating 21. As with the case of the first coating 17, the second coating 21 has a characteristic structure involving pores and fine powder, and, at a boundary of the second coating 21 and the friction portion 15t, a fusion layer B2 in which a composition gradiently changes in its thickness direction is generated. As with the case of the first coating 17, the thickness of the fusion layer B2 is preferably made to be 1 μm or more and 10 μm or less, or more preferably 3 μm or more and 10 μm or less, by being controlled by an appropriate discharge condition. An appropriate discharge condition is that a peak current is 30A or less and a pulse width is 8 μs or less, or more preferably a peak current is 20A or less and a pulse width is 8 μs or less.

Meanwhile, if the discharge-deposition is executed in a processing liquid L such as oil at a time of formation of the first coating 17, subsequently the second coating 21 may be formed by executing discharge-deposition in the processing liquid L such as oil. Alternatively, the similar applies to a case where it is executed in an inert gas such as argon. Further, the first coating 17 may use the processing liquid L and the second coating 21 may use the inert gas, or vice versa.

In the meantime, prior to the discharge-deposition, the subject may be heated up to a brittle-ductile transition temperature of the applied TiAl intermetallic compound, or higher, by means of any proper method using a light source or a high-frequency heating, and discharge-deposition with keeping the temperature and subsequent annealing may be executed. Brittle-ductile transition temperatures of TiAl intermetallic compounds are publicly known as being definite depending on compositions and microscopic structures of the TiAl intermetallic compounds, as described in the academic journal of The Minerals, Metals & Materials Society, JOM (August, 1991), FIG. 8 on page 48 and the right column on page 44 through the left column on page 45. For example, the TiAl intermetallic compound having a composition of 48Ti-48Al-2Cr-2Nb has a brittle-ductile transition temperature in the range of from 550 through 750 degrees C. as depending on its microscopic structure. The brittle-ductile transition temperature can be easily measured by a publicly known method.

The temperature of the subject body is preferably prevented from excessively falling during the discharge-deposition, however, it is not necessarily kept constant. One just have to maintain a temperature at the brittle-ductile transition temperature or higher. The inert gas may be introduced through any ventilation system specially provided, however, one may use the electrode having a course structure to inject the inert gas. The inert gas injected from the electrode cools the space between the face subject to discharge-deposition and the electrode, and further has an effect of removing sludge around the subject face. In this case, a processing liquid L is not poured into the processing bath 29 and instead the discharge-deposition is executed in the inert gas.

By executing the aforementioned steps, a heat-resistant component comprising a main body of a TiAl intermetallic compound, and one or more coatings coated on a particular region of the main body, including an abrasion-resistant substance or a substance having abrasiveness, which are deposited by discharge-deposition from a processing electrode including the abrasion-resistant substance or the substance having abrasiveness on the particular region, is obtained.

In the aforementioned descriptions, the rotor blade of the gas turbine engine is exemplified as the heat-resistant component for explanation, however, the present invention is not limited thereto. The present invention can be applied to any component required to have heat-resistance and be treated with coating, such as stator vanes, rotor disks, impellers of supercharges or such for example. Further, the discharge-deposition can be executed in not only a liquid but also a gas.

In accordance with a coating technique by deposition such as welding, because a fused material is made to adhere on a subject region, the amount of heat input per unit area onto the subject region is relatively large and further large area is subject to the heat input. Therefore, the degree of thermal expansion in the course of the heating is large and thereby tensile stress in the course of cooling must be large to this extent. The combination of the coating technique and the TiAl intermetallic compound gives rise to high probability to generate cracks caused by contraction in the course of cooling. Further, even in the course of the heating, expansion of the surface caused by the heating may cause generation of cracks just under the surface. Moreover, the coating made by spraying is likely to exfoliate. In contrast, according to the present embodiment, the coating technique by discharge-deposition and the TiAl intermetallic compound are combined. In the discharge-deposition, heat input onto the subject body is limited to a spot where discharge is generated and further the discharge is pulsing and intermittent. Therefore, the degree of expansion of the subject region is small and therefore generation of excessive tensile stress in the course of cooling can be avoided. More specifically, generation of cracks can be suppressed. The combination of the coating technique by discharge-deposition and the TiAl intermetallic compound provides a prominent effect in light of suppression of cracking.

In the present embodiment, furthermore, as the subject body is heated at a brittle-ductile transition temperature or higher, temperature difference between the coating and the subject body is reduced, thereby suppressing generation of cracks caused by the thermal stress. Further, as coating is formed in a condition where the subject has ductility, generation of cracks is further suppressed. Moreover, as discharge-deposition is executed in oil including fine powder having conductivity, local heating caused by concentration of discharge is suppressed and this leads to further suppression of generation of cracks. Furthermore, as peening is executed prior to the discharge-deposition, compression stress balanceable with tensile stress is given. Thereby tensile stress just under the fusion portion is suppressed and this leads to suppression of generation of cracks. Alternatively, even if cracks are generated in the fusion portion and where just under the portion, residual compression stress deters progress of the cracks. Thereby fatigue strength can be increased.

Further, as the heat-resistant component comprises a coating having abrasiveness, which includes a metal including one selected from the group of cobalt alloys and nickel alloys, and a ceramic of any one or more selected from the group of cBN, TiC, TiN, TiAlN, TiB₂, WC, SiC, Si₃N₄, Cr₃C₂, Al₂O₃, ZrO₂—Y, ZrC, VC, and B₄C, the heat-resistant component has high abrasiveness.

Further, in accordance with the coating technique by discharge-deposition, a region where the coating is formed can be limited within a region to which the electrode is closed. If the electrode is formed in a desired shape, the region where the coating is formed can be defined without any other means. If one would realize this by means of other techniques such as spraying, he or she must mask regions except the subject region with any heat-resistant material in advance and is further required to remove the mask after completion of coating. In contrast with this, the present embodiment provides an efficient production method in which steps are simplified.

Further, in accordance with the discharge-deposition, as compared with coating techniques by vapor deposition methods or plating methods, the growth rate of thickness of the coating is greater, thereby enabling shorter time to obtain a required thickness.

Influence of coatings on a fatigue life has been tested by a low cycle fatigue (LCF) test. This test method is in compliance with the regulation JIS-Z2279 in principle, and detailed conditions such as a test temperature are indicated as in Table 2. Test pieces are solid round bars compliant with the regulation, and dimensions of these parallel portions are 3 mmφ×6 mm and these shoulders are rounded in R12 mm. Side faces except grip sections are finished in a surface treatment as indicated in Table 3 over the length. No. 4 and 6 are what is treated with the coating in accordance with the above disclosure, in which the applied peak current is 2A and the pulse width is 2 μs. No. 7 and 9 are comparative examples not treated with any surface treatment. No. 10 and 12 are treated with a blasting treatment which imitates a case where coatings are formed by spraying.

TABLE 2
LCF test condition

| | |
|---|---|
| Temperature | 538 degrees C. |
| Max load σₘₐₓ | 370 MPa |
| Stress ratio | R = 0.1 |
| Waveform | sine wave |

TABLE 3
test pieces applied to the LCF test and its results

| | | Cycles to cause |
|---|---|---|
| No. | Surface treatment | fracture (Cycles) |
| 4 | With coatings | 3.16 × 10³ |
| 5 | (peak current = 2 A, | 3.08 × 10³ |
| 6 | pulse width = 2 μs) | 1.79 × 10⁴ |
| 8 | None | 5.82 × 10³ |
| 9 | | 7.35 × 10⁵ |
| 10 | With blasting | 1.32 × 10⁴ |
| 11 | (imitating | 1.63 × 10³ |
| 12 | sprayed surfaces) | 2.59 × 10³ |

Cycles to cause fracture are enumerated in the right column of Table 3. When the fatigue lifetimes are estimated by minimums among the cycles causing fracture, the test pieces with coatings apparently have longer fatigue life than those treated with blasting which imitates sprayed components. More specifically, the disclosed art as described above is understood to provide a coating which suppresses shortening of fatigue life.

Although the invention has been described above by reference to certain embodiments of the invention, the invention is not limited to the embodiments described above. Modifications and variations of the embodiments described above will occur to those skilled in the art, in light of the above teachings.

### INDUSTRIAL APPLICABILITY

Heat-resistant components of TiAl intermetallic components with coatings, which prevent cracks and suppress reduction of strength of these base members even if the cracks are generated on its surface, are provided.

1. A heat-resistant component subject to friction with an other component under high-temperature environments, the heat-resistant component comprising:
a main body of a TiAl intermetallic compound having a friction face subject to friction with the other component; and
an abrasion-resistant coating coated on the friction face, the abrasion-resistant coating being formed by executing discharge-deposition by a consumable electrode of an abrasion-resistant metal.

2. The heat-resistant component of claim 1, wherein the main body is heated at a brittle-ductile transition temperature or higher temperatures prior to the discharge-deposition.

3. The heat-resistant component of claim 1, wherein the abrasion-resistant coating is formed by executing the discharge-deposition in oil including fine powder.

4. The heat-resistant component of claim 1, wherein the friction face is treated with a peening treatment prior to the discharge-deposition.

5. The heat-resistant component of claim 1, wherein the abrasion-resistant coating comprises a Co alloy including Cr.

6. The heat-resistant component of claim 1, wherein the consumable electrode is formed from a powder comprising a Co alloy including Cr by any method selected from the group of compression, compression and at least partial sintering after the compression, slip casting, MIM, and spraying.

7. The heat-resistant component of claim 1, further comprising:
a fused layer in which a composition gradiently changes in a thickness direction, between the coating and the main body.

8. A heat-resistant component subject to friction with an other component under high-temperature environments, the heat-resistant component comprising:
a main body of a TiAl intermetallic compound having a friction face subject to friction with the other component; and
a coating having abrasiveness coated on the friction face, the coating being formed by executing discharge-deposition from a consumable electrode of a metal having abrasiveness and a ceramic.

9. The heat-resistant component of claim 8, wherein the main body is heated at a brittle-ductile transition temperature or higher temperatures prior to the discharge-deposition.

10. The heat-resistant component of claim 8, wherein the coating of abrasiveness is formed by executing discharge-deposition in oil including fine powder.

11. The heat-resistant component of claim 8, wherein the friction face is treated with a peening treatment prior to the discharge-deposition.

12. The heat-resistant component of claim 8, wherein the coating having abrasiveness comprises a metal and a ceramic, the metal including one selected from the group of cobalt alloys and nickel alloys, the ceramic including one or more selected from the group of cBN, TiC, TiN, TiAlN, TiB₂, WC, SiC, Si₃N₄, Cr₃C₂, Al₂O₃, ZrO₂—Y, ZrC, VC, and B₄C.

13. The heat-resistant component of claim 8, wherein the consumable electrode comprises a metal and a ceramic, the metal including one selected from the group of cobalt alloys and nickel alloys, the ceramic including one or more selected from the group of cBN, TiC, TiN, TiAlN, TiB₂, WC, SiC, Si₃N₄, Cr₃C₂, Al₂O₃, ZrO₂—Y, ZrC, VC, and B₄C, the consumable electrode being formed from a powder of the metal and the ceramic by any method selected from the group of compression, compression and at least partial sintering after the compression, slip casting, MIM, and spraying.

14. The heat-resistant component of claim 8, further comprising:
a fused layer in which a composition gradiently changes in a thickness direction, between the coating and the main body.
